(19) United States
(12) Patent Application Publication
(10) Pub. No.: US 2024/0054762 A1
(43) Pub. Date: Feb. 15, 2024

(54) Helmet inside trunk detection system for mobility sharing service

(71) Applicant: Reby Inc., Walnut, CA (US)

(72) Inventors: Julio Gonzalez Lopez, Igualada (ES); Elisabet Bayo Puxan, Barcelona (ES); Akash Kadechkar, Barcelona (ES); Xiaolei Song, Barcelona (ES); Ricard Comas Xanco, Tordera (ES); Eugeni Llagostera Saltor, Barcelona (ES)

(21) Appl. No.: 17/819,312

(22) Filed: Aug. 12, 2022

(51) Int. Cl. G06V 10/764; G06V 10/774; G06V 10/75; B62J 11/24

(52) U.S. Cl. CPC G06V 10/764; G06V 10/774; G06V 10/759; B62J 11/24; B62K 3/002

(57) ABSTRACT

An image classification system and method are used to determine the status of equipment completeness of the rental two-wheeled vehicles, such as electric scooters. The system and method use deep learning models to analyze and classify ambiguous states of the rental vehicle when the user finishes the ride. These states are likely to be encountered by rental vehicles, to protect helmets, trunks or other equipment from loss or damage.

### FIELD OF THE INVENTION

The invention pertains to the field of vehicles rental services and methods for determining equipment completeness for such vehicles in various environments.

### BACKGROUND

When a rider finishes a ride using a shared vehicle, such as an electric scooter, a picture of the vehicle is usually required. This image is used to verify compliance with the terms of use of the rental facility. The conditions may vary, but usually contain safety requirements, such as parking rules, the absence of unaccounted damages, the rules for installing a lock on a vehicle, and others. At the same time, driving a two-wheeled vehicle requires the wearing of safety helmets. For transport and storage of two helmets in compact vehicles such as an electric scooter, a special luggage carrier or a trunk is provided. Scooter rental services incur high costs in case of loss, theft, or breakage of helmets, so there is a need in this field to ensure that when dropping off a scooter at a random location, it is technically possible to make sure that the scooter is equipped with helmets and a trunk. Additionally, the luggage compartment can be equipped with other equipment, such as a pump, vest or first aid kit. They also need to be controlled. In existing solutions, the problem is solved with the help of a check weight in the trunk or with the help of special electronic locks built into the helmet mount, using electronic beacons. These solutions have a number of disadvantages, such as the inability to identify the helmet and, as a result, to detect a replacement, the inability to determine the presence of damage on the helmet, and the inability to check the completeness of the equipment kit together with the helmet using one technical tool.

A solution is needed with the ability to classify the status of equipment completeness of the shared two-wheeled vehicle that minimizes human review, minimizes operation resources and achieves accurate results in ambiguous cases. The tools used for such a solution must work effectively with the constraints imposed by the vehicle platform.

### SUMMARY OF THE INVENTION

When a driver finishes a ride, a cloud-based service with trained image analyzer and classifier models is ready to predict the state of the vehicle equipment completeness. The service is optimized to predict the state of two-wheeled vehicles generally and scooters in particular. Scooters include kick scooters, kick scooters with some form of power assistance, and fully electric scooters. The invention also applies to future scooter designs that employ a platform similar to conventional scooters. Image recognition techniques targeted on the vehicle exterior and the inner space of the trunk define the construction feature of the trunk, which frame or body must be fully or partly transparent. Results of image analysis and classification are saved so that the accuracy of these analyses and classifications can be measured, tested, and used to improve the accuracy of future classifications.

The invention solves a problem encountered specifically by two-wheeled vehicles. Unlike automobiles, two-wheeled vehicles can be equipped with a special transparent trunk that can securely store two helmets. The invention can be implemented to detect and identify helmets with specific design, logo, or code, to exclude a replacement of helmets.

In an embodiment, the method for checking the equipment completeness of the rental two-wheeled vehicle comprises training an object detection machine-learning model and state determination machine-learning model using multiple equipped vehicle training images, where each of the training images is associated with a known equipment completeness status. Training images and associated known equipment completeness status are input into an object detection model and state determination model as training data to generate a vehicle equipment completeness classification rule.

In an embodiment, training images may contain at least one image of the vehicle without the trunk, the vehicle with empty mounted trunk, the vehicle with a trunk containing one helmet, the vehicle with a trunk containing two helmets The machine-learning models in conjunction with classification rules may comprise Logistic Regression, K-Nearest Neighbor, Support Vector Machine, Random Forest, Neural Networks, or a combination of one or more of these rules.

### DESCRIPTION OF THE DRAWINGS

FIG. 1 shows an exemplary interaction between a rider's mobile device and an embodiment of the cloud-based service for determining vehicle equipment state and for guiding a rider to successfully complete the ride.

FIG. 2 shows a system for checking the equipment completeness of the rental two-wheeled vehicle.

FIG. 3 shows a method for checking the equipment completeness of the rental two-wheeled vehicle.

FIG. 4 shows a view of a vehicle equipped with a trunk containing two helmets.

### DETAILED DESCRIPTION

The solution comprises a series of steps. In an exemplary embodiment, four steps are used.

At the first step, training images are collected. In an embodiment, the collected images are actual ride finish pictures from users of the scooter that is equipped with a trunk and one or more helmets from any operating city at any location and time of day or night. The ride finish location and its timestamp are included, together with the picture and state.

At the next step, training images are associated with an equipment state. For example, in an embodiment, the number of possible states is divided into the following categories: 1) the image doesn't contain vehicle 2) the image doesn't contain the trunk 3) the image doesn't contain helmets 4) the vehicle is without a trunk, 5) the vehicle is equipped with a trunk, 6) the vehicle is equipped with a broken trunk, 7) the vehicle is equipped with a trunk with dirty transparent frame, 8) the vehicle is equipped with an empty trunk, 9) the vehicle is equipped with a trunk containing one helmet, 10) the vehicle is equipped with a trunk containing two helmets, 11) the vehicle is equipped with a trunk containing unfamiliar helmet, 11) the vehicle is equipped with a trunk containing undetermined object, 12) the trunk is unmounted from the vehicle, 13) helmets are outside the trunk, 14) low quality image. In another embodiment, the number of processing categories can be decreased, to optimize the processing resources. For example, to detect the completeness of two helmets in the trunk there should be defined four states: 1) No transparent trunk in the picture or unrecognizable picture, 2) Transparent trunk detected with zero helmets, 3) Transparent trunk detected with 1 helmet, 4) Transparent trunk detected with 2 helmets.

As the third step, a first deep learning model is trained to detect a scooter and the equipment objects including a trunk and a helmet in collected images.

At the fourth step, a second deep learning model is trained to analyze the relative position of detected objects to determine if the vehicle is equipped fully and correctly or not. Both models are trained using pictures, which may be from the same or different cities. The training includes data augmentation and brightness, contrast, rotation, size, and other image parameters that are modified to increase the model's robustness. Once the model is trained, it is employed to predict a given ride's finish picture state. Two deep learning models can be complemented into a single model, which can be trained to detect objects and to determine the state of their relative position at once, combining third and fourth steps into one. In this case adding another object into classification or changing the corporate design of the helmet or scooter will lead to re-training of the whole model. More efficient would be to sequence two models.

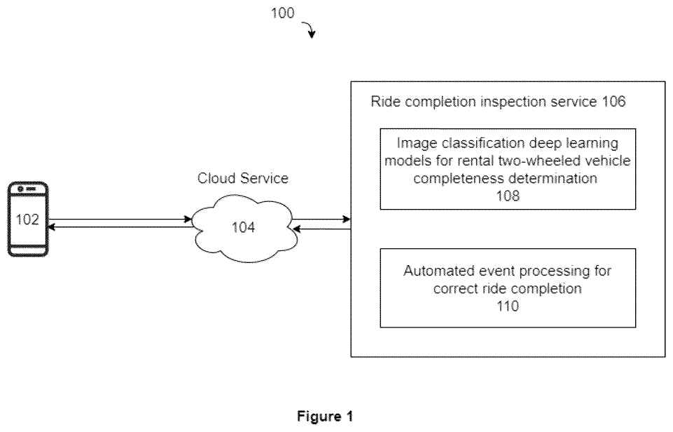

FIG. 1 shows a system 100 with exemplary interactions between a driver's mobile device 102 and an embodiment of cloud-based service 104 for processing ride completion workflow. In communication with cloud-based service 104 is ride completion inspection service 106. This service comprises Image classification deep learning models 108 for rental two-wheeled vehicle completeness determination and automated event processing 110 for correct ride completion. Two-communication exists between mobile device 102 and cloud-based service 104. There is also two-way communication between cloud-based service 104 and ride completion inspection service 106.

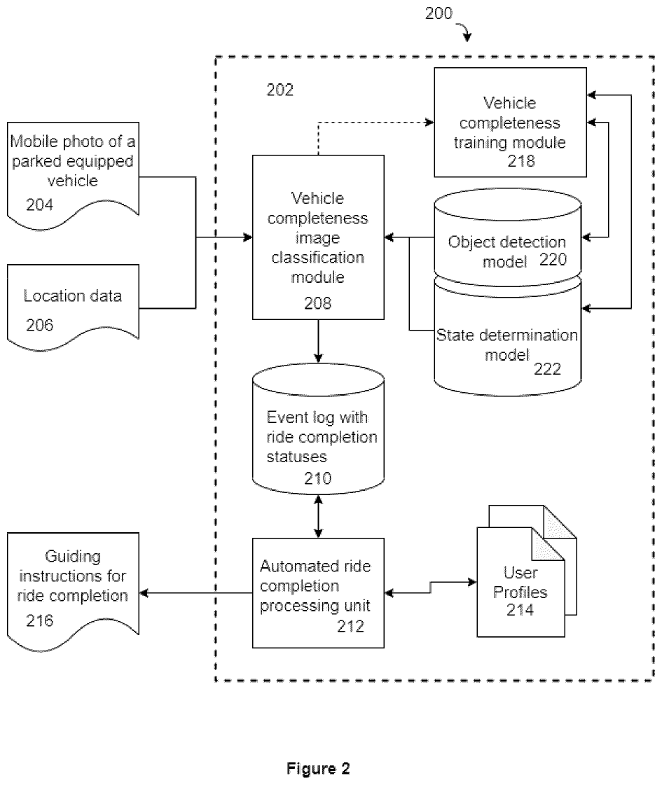

FIG. 2 shows details of a system 200 for checking the equipment completeness of the rental two-wheeled vehicle. The system comprises a collection 202 of connected components configured to receive a mobile photo 204 of a parked equipped vehicle, such as a scooter equipped with a trunk and helmet. Location data 206 is sent with mobile photo 204 to vehicle completeness image classification module 208. The output of vehicle completeness image classifications is communicated to the event log with ride completion statuses 210. This event log communicates with automated ride completion processing unit 212. This unit 212 queries and receives user profiles from saved user profiles 214, which correspond to scooter users. The output of processing unit 212 is a set of guided instructions for ride completion 216.

Vehicle completeness image classification module 208 also sends its output to vehicle completeness training module 218 to update the training dataset. This module 218 communicates with a database comprising object detection model 220 and state determination model 222. The output of object detection model 220 and state determination model 222 is further communicated to vehicle completeness image classification module 208 and used to generate image classifications. The object detection model 220 and state detection model 222 represent machine learning models, in particular deep learning models, that contain object and class definitions, predicted probabilities functions, feature weights and other identical characteristics of machine-learning models. These models are separated into independent models that are processed sequentially. In alternative embodiment these models could be aggregated into one machine learning model for object detection and state classification.

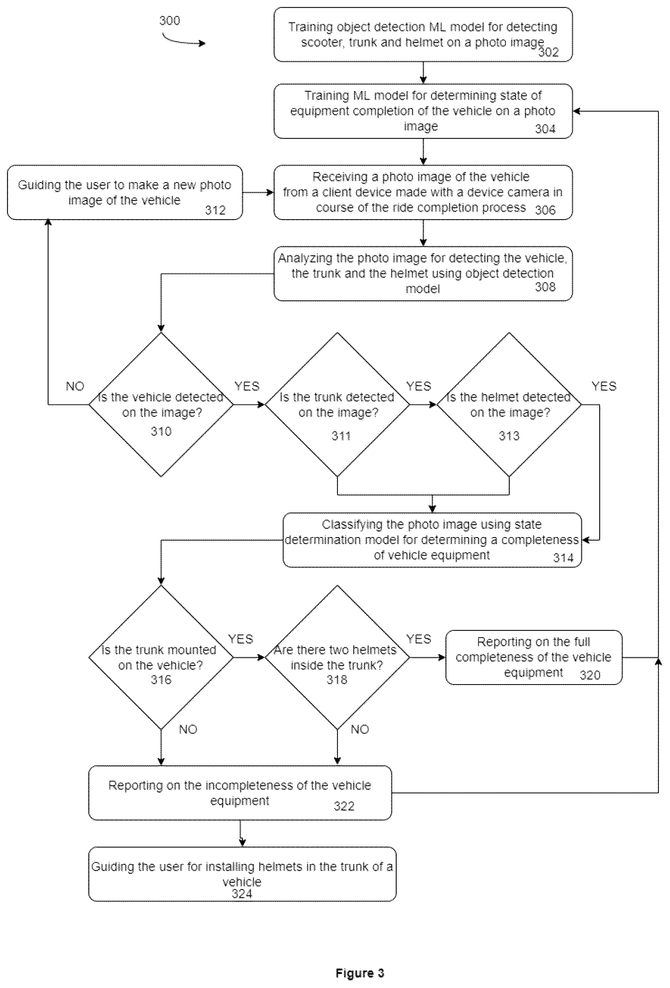

FIG. 3 shows a method 300 for checking the equipment completeness of the rental two-wheeled vehicle, including feedback to the driver of vehicles, such as scooters. This method 300 is used with systems such those shown in FIGS. 1 and 2. At block 302, the step of training a machine learning model for detecting objects comprising scooter, trunk and helmet in a photo image is performed. The list of the objects can be expanded to other scoter equipment like pump, lock, raincoat, and others. Then at block 304 follows the step of training a machine learning model for determining the state of equipment completion of the vehicle on a photo image with the detected objects. At the following block 306, a photo image of the parked scooter is received from a client device made with a device camera in course of ride finishing process. In this context, the client is a scooter user, and the device camera refers to this client scooter user's mobile device. This photo image is analyzed for detection of vehicle, trunk and helmet using the object detection deep learning model at block 308.

The analysis for the image results in a decision about whether an object is detected at blocks 310, 311, 313. If no vehicle is detected at block 310 or no trunk is detected at block 311 or no helmet is detected at block 313 or objects are detected with low accuracy or partly, then at block 312 a remade photo image is expected from block 306. At step 314 the photo image is classified using a state determination model for determining a completeness of vehicle equipment based on the result or verdict of object detection analysis. Then at blocks 316, 318 a decision is made whether the vehicle is equipped with a trunk and helmets correctly. If yes, then completeness status of the vehicle equipment is reported at block 320. If no, then incompleteness status of the vehicle equipment is reported at block 322. Reporting means logging, notifying, alerting, or storing events to an event database for further operation of automated ride completion processing unit 212 and forming updated dataset for training machine learning models. The output of block 3122 comprises guiding the user for correct ride completion 318, for example guiding the user to correctly install helmets in the trunk. Guiding instructions can be in the form of readable text, reference pictures, schemas or figures and may pay attention to violation consequences.

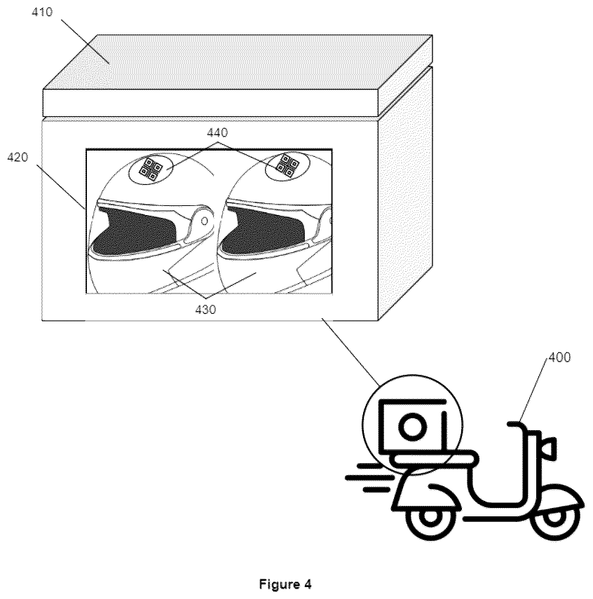

FIG. 4 shows a scooter, for example, an electric scooter 400, equipped with the trunk 410. The trunk has a transparent frame 420, to observe the interior of the trunk and make packed helmets 430 visible from the outside on a photo image. In alternative embodiment the trunk can be fully transparent or can have a transparent side of the body. In some embodiments the object detection model is trained to detect specific types of helmets, for example helmets, that are labeled or marked with a code, QR-code 410 or that have a specific corporate design, like color or painting.

The photo image should display all objects shown in FIG. 4 in accordance with rental service terms. If this particular scooter 400 was equipped with one helmet 430 then only one helmet packed in the trunk with visible QR-code 440 should be captured on a camera. Otherwise, users will be guided to remake a photo or fix the vehicle equipment.

In an embodiment, classification model training and testing is implemented using TensorFlow or similar software. Appropriate languages comprise Python, C++, and CUDA. The tools used in the systems and methods implementing the invention analyze object detection and state determination sequentially.

The detection of a vehicle, trunk and helmets, or non-detection of a vehicle—takes place before the state classification. This sequential processing is adapted to the specific context of vehicles, such as scooters, which may be equipped with a wide variety of helmets and equipment. Further, the capture of the scooter with a camera is prone to error because of the relatively small size of the vehicle and the increased possibility of inaccurate photo images due to the user's use of a handheld camera in unpredictable environments.

In an embodiment, the reduction of the number of classes that must be distinguished is achieved by training the model in stages. For example, a first model is trained to distinguish high-level details, such as whether the vehicle and equipment are visible. The second model, trained to distinguish equipment completeness states, will have a lower error rate because it only classifies images that have visible objects. For example, details like random or unrecognizable objects or detailed structures such as benches or racks will result in errors if the model must both determine the presence of a vehicle and classify its equipment completeness state. A multiple-model system is therefore used to optimize the process. In an exemplary embodiment, the first model's classification task is simplified, such as determining whether a vehicle is visible or not visible and a second model's classification task is more difficult, such as detecting a relative position of detected objects in a wide range of environments.

A multiple-stage process, such as using a first model to determine if a vehicle is in the picture, also results in fast feedback to the user. System resources are optimized, and processing times improved when cases where a vehicle is not visible are filtered. This helps the system avoid processing unnecessary pictures with a model that must search and evaluate more classes. Avoiding the processing of unnecessary pictures saves compute resources and results in faster classification.

1. A method of checking the equipment completeness of the rental two-wheeled vehicle, comprising the steps of:
a. training image classification deep learning models for equipment completeness of the vehicle determination, further comprising the steps of:
obtaining multiple training images of the vehicle with a trunk, wherein each of the training image is associated with a known state of helmet completeness in the trunk mounted on the vehicle;
loading the training images with associated known vehicle equipment completeness states into a vehicle completeness training module as training data;
generating an object detection model for detecting the trunk and the helmet based on the training data using the vehicle completeness training module; and
generating a state determination model for determining equipment completeness of the vehicle using vehicle completeness training module; and
b. determining an equipment completeness of the vehicle, further comprising the steps of:
receiving a photo image of the vehicle from the client device, wherein the photo image captures the trunk and was made with a client device camera;
analyzing the photo image using object detection model for detecting the trunk and the helmet on the photo image; and
classifying the photo image using state determination model for determining a class of the photo image associated with equipment completeness state of the vehicle; and
c. forming an instruction in accordance with determined state of equipment completeness of the vehicle related to a class of the photo image and verdict of the object detection on the photo image.

2. The method of claim 1, wherein the training images contain at least one image of an empty trunk, a trunk containing one helmet, a trunk containing two helmets.

3. The method of claim 2, wherein the training images capture the vehicle on which the trunk is mounted.

4. The method of claim 1, wherein the photo image is captured in course of the ride completion workflow.

5. The method of claim 1, wherein the trunk contains at least one transparent frame.

6. The method of claim 1, wherein the trunk has a transparent body.

7. The method of claim 1, wherein the state determination model comprises techniques based in Logistic Regression, K-Nearest Neighbor, Support Vector Machine, Random Forest, Neural Network, or any combination thereof.

8. The method of claim 1, further comprising the step of guiding the user to make a new photo image if the verdict of the object detection is negative.

9. The method of claim 1, further comprising the step of guiding the user for installing helmets in the trunk of a vehicle if the verdict of the state determination is negative.

10. A system for checking the equipment completeness of the rental two-wheeled vehicle, the system comprising:
a processor, connected to the network and configured to receive photo images from the users of vehicles;
a vehicle completeness training module, configured to load training images with associated known vehicle equipment completeness states;
an object detection model for detecting the trunk and the helmet on the photo image based on the training data from the vehicle completeness training module;
a state determination model for classifying the photo image to determine a class of the photo image associated with equipment completeness state of the vehicle;
a vehicle completeness image classification module that determines the state of the equipment completeness of the vehicle based on the verdict of object detection model and the verdict of the state determination model; and
an automated ride completion processing unit that structs the user of the vehicle in response to the determined state of the equipment completeness of the vehicle.

11. The system of claim 10, wherein the training images contain at least one image of an empty trunk, a trunk containing one helmet, a trunk containing two helmets.

12. The system of claim 11, wherein the training images capture the vehicle on which the trunk is mounted.

13. The system of claim 10, wherein the photo image is captured in course of the ride completion workflow.

14. The system of claim 10, wherein the trunk contains at least one transparent frame to observe helmets inside.

15. The system of claim 10, wherein the trunk has a transparent body to observe helmets inside.

16. The system of claim 10, wherein the state determination model comprises techniques based in Logistic Regression, K-Nearest Neighbor, Support Vector Machine, Random Forest, Neural Network, or any combination thereof.

17. The system of claim 10, wherein the automated ride completion processing unit is configured to guide the user to make a new photo image if the verdict of the object detection is negative.

18. The system of claim 10, wherein the automated ride completion processing unit is configured to guide the user for installing helmets in the trunk of a vehicle, if the verdict of the state determination is negative.
